(19) United States
(12) Patent Application Publication
(10) Pub. No.: US 2010/0228817 A1
(43) Pub. Date: Sep. 9, 2010

(54) DISTRIBUTED PROCESSING SYSTEM, CONTROL UNIT AND CLIENT

(75) Inventors: Arata SHINOZAKI, Tokyo (JP); Misunori Kubo, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/716,398

(22) Filed: Mar. 3, 2010

(30) Foreign Application Priority Data
Mar. 4, 2009 (JP) 2009-050641

(51) Int. Cl. G06F 15/16

(52) U.S. Cl. 709/203

(57) ABSTRACT

A distributed processing system includes a client that makes an execution request for a service requested by a user, a processing element, and a control unit to which the client and the processing elements are connected. The client stores therein execution transition information about computational resources and processing paths required for controlling the processing element. The processing element executes tasks constituting the service according to the execution transition information.

### CROSS-REFERENCE TO RELATED APPLICATION

The present application is based upon and claims the benefit of priority from the prior Japanese Patent Application No. 2009-050641 filed on Mar. 4, 2009; the entire contents of which are incorporated herein by reference.

### BACKGROUND OF THE INVENTION

1. Field of the Invention

The present invention relates to a distributed processing system, a control unit, and a client.

2. Description of the Related Art

A distributed processing system that includes a control unit and at least one processing element that is connected to the control unit is known in the art. In the distributed processing system, execution transition information about computational resources and processing paths is generated in response to a service requested by a client, and according to the generated execution transition information, tasks constituting the service are executed in the processing elements allocated as computational resources. Moreover, in order to omit the step of reconfiguring the system by using the execution transition information, a technique has been disclosed in which information is cached and validity is assessed. Such a parallel processing system has been disclosed, for example, in Japanese Patent No. 3184535.

### SUMMARY OF THE INVENTION

A distributed processing system according to the present invention includes a client that makes an execution request for a service requested by a user, a processing element, and a control unit to which the client and the processing elements are connected. The client stores therein execution transition information about computational resources and processing paths required for controlling the processing element. The processing element executes tasks constituting the service according to the execution transition information.

A control unit according to the present invention is connected to a client that makes an execution request for a service, and a processing element. The control unit includes a determining unit that receives, when the execution request for the service is made by the client, execution transition information corresponding to the service from among execution transition information stored in the client and performs a validity determination of the execution transition information. The control unit notifies the client of a result of the validity determination made by the determining unit.

A client according to the present invention is connected to the control unit of a distributed processing system. The client makes an execution request for the service requested by a user, and stores therein execution transition information about computational resources and processing paths required for controlling a processing element.

### BRIEF DESCRIPTION OF THE DRAWINGS

FIG. 1 is a schematic diagram of a distributed processing system according to an embodiment of the present invention;

FIG. 2 depicts a service-task correspondence table that contains a correspondence between services and tasks that constitute the services;

FIG. 3 is a table showing exemplary items of information constituting the execution transition information and exemplary data of the respective items of the information.

FIG. 4 is a sequence diagram of a process procedure from allocation of computational resources up to deallocation of the computational resources by a control unit based on the execution transition information;

FIG. 5 is a flowchart of an application process corresponding to the service-task correspondence table shown in FIG. 2;

FIG. 6 is a schematic diagram of an exemplary model of a system that is compatible with the configuration of the execution transition information;

FIG. 7 is a schematic diagram of an exemplary screen of a client application that is used for decoding and displaying images;

FIG. 8 is a flowchart of an application process corresponding to the service-task correspondence table shown in FIG. 2 and corresponds to a case where a high security level has been configured;

FIG. 9 is a schematic diagram of an exemplary model of a system that is compatible with the configuration of the execution transition information;

FIG. 10 is a schematic diagram of an exemplary screen of a client application that is used for decoding and displaying images and corresponds to a case where a high security level has been configured; and

FIG. 11 is a flowchart for explaining a process procedure performed by the client.

### DETAILED DESCRIPTION OF THE INVENTION

Exemplary embodiments of a distributed processing system, a control unit, and a client according to the present invention are explained below with reference to the accompanying drawings. The embodiments explain a distributed processing system according to the present invention that is adapted for a JPEG decoding process. However, the scope of the invention is not limited to the process explained in the embodiments.

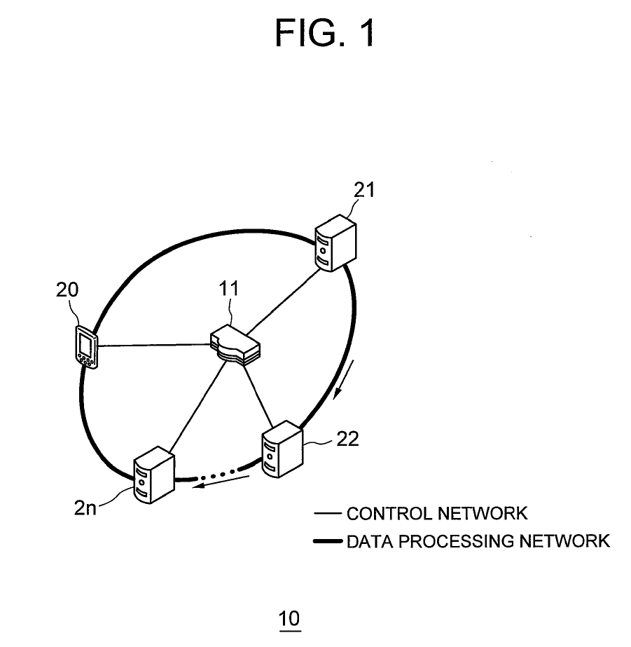

FIG. 1 is a schematic diagram of a distributed processing system according to an embodiment of the present invention. In FIG. 1, thick lines indicate a data processing network and thin lines indicate a control network. As shown in FIG. 1, a distributed processing system 10 according to the present embodiment includes: (A) a control unit (CU) 11; and (B) a plurality of processing elements (PE) 20, 21, 22, . . . , 2n having a function for executing tasks. The processing element 20 among the processing elements 20, 21, 22, . . . , 2n, is assume to be a service requesting processing element (client) that makes a service request.

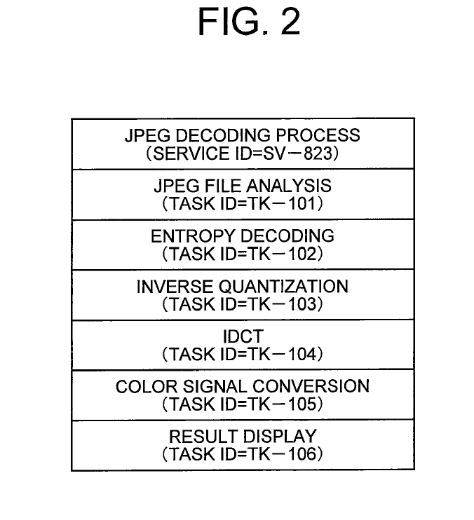

The term “service” refers to a process unit that provides processing, such as multimedia processing, that is of some value to users. For example, a JPEG decoding process is a service that presents images to the users in a recognizable form, and in this case, a unique identifier (ID) assigned to each service for identifying the service is called a service ID. For example, the unique identifier of the JPEG decoding process is SV-823. On the other hand, the term “task” refers to process unit that constitute a service. Thus, a service is made of more than one task. For example, as shown in FIG. 2, the JPEG decoding process can be made of six tasks from JPEG file analysis to result display. FIG. 2 depicts a service-task correspondence table that contains a correspondence between a service and tasks that constitute the service. A unique identifier (ID) assigned to each task for identifying the task is called a task ID. For example, the task ID of one of the tasks, entropy decoding, is TK-102.

The control unit 11 can decompose a service into tasks by referring to the service-task correspondence table. For example, the JPEG decoding process (service ID=SV-823) is made of total six tasks: JPEG file analysis (task ID=TK-101), entropy decoding (task ID=TK-102), inverse quantization (task ID=TK-103), IDCT (task ID=TK-104), color signal conversion (task ID=TK-105), and result display (task ID=TK-106). Each of the processing elements 20, 21, 22, . . . , 2n has a unique function and is capable of executing not less than one task. Each function of each of the processing elements is assigned with a function ID and each function ID is associated with the task ID. For example, a processing element that is assigned with a function ID FN-101 executes the task having the task ID=TK-101.

The term “control unit” refers to a unit in the distributed processing system and it performs functions such as assigning tasks to the processing elements, managing processing paths, and managing execution status transitions during service execution. The term “processing element” (denoted as “PE” in the diagrams) refers to a configuration unit that constitutes a system and that can realize one or more of the following four functions: data input/output, processing, transmission, and storage. Each processing element generally has the functions of processing one or more tasks as well as input/output function and storage function for data that is necessary for the processing.

The control unit 11 inquires, to each of the processing elements connected to it, information about the function the processing element can perform (types of tasks executable by the processing element) and its computational resources (throughput, memory capacity, etc.) and records therein the information received from the processing element. Instead of the control unit 11 inquiring this information to the processing elements, a configuration can be adopted in which the processing elements send the required information to the control unit 11. When recording the processing elements 20, 21, 22, . . . , 2n, the control unit 11 assigns a unique identifier (PEID) that is decided in the distributed processing system 10 to the processing elements 20, 21, 22, . . . , 2n. The PEID is assigned when the distributed processing system is booted or rebooted.

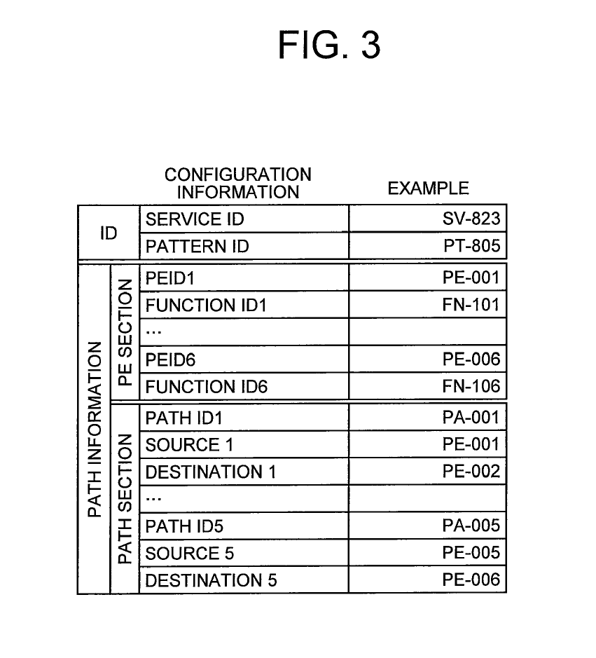

The control unit 11 manages the status of the computational resources and the processing paths and provides a service according to the execution transition information provided by the client 20. The term “execution transition information” refers to a combination of the computational resources and the processing paths necessary for the execution of the service and management information thereof. The execution transition information can be represented in the form of a task execution transition table shown in FIG. 3. FIG. 3 is a table showing exemplary items of information constituting the execution transition information and exemplary data of the respective items of the information. More particularly, the task execution transition table contains a listing of ID and path information. The path information further includes a path section and a processing element section.

As shown in FIG. 3, the execution transition information further includes an ID and the path information. The ID further includes a service ID and a pattern ID. Attention is drawn to the fact that the data structure of the execution transition information is not limited to that mentioned here. For example, a data structure can be adopted in which the execution transition information includes path information that further includes computational resources and processing paths, and management information thereof.

The term “pattern” refers to a permutation of the computational resources (i.e., processing elements) and the processing paths. The term “service ID” refers to an identifier (ID) assigned to each service to uniquely identify the service.

The term “pattern ID” refers to an identifier assigned to each pattern to uniquely identify the pattern. For example, assume now that there are processing elements A, B, C, D, and E, and that JPEG encoding can be carried out by a pattern comprising either of paths formed in the sequence of the processing elements A, B, and C, and in the sequence of the processing elements A, B, D, and E. In this example, each of the paths is assigned a unique pattern ID.

The path information includes the processing element section and the path section. The processing element section includes the PEIDs and the function IDs of the processing elements. The path section includes path IDs, sources, and destinations.

The term “path ID” refers to an identifier uniquely assigned to a communication path between two processing elements. The source is the ID of an input-end processing element, and the destination is the ID of an output-end processing element forming the path between two processing elements. The connections relation between the client and the processing elements 20, 21, 22, . . . , 2n that form the paths can be determined from the path ID, the source, and the destination.

The client 20 stores the execution transition information in the form of a database in a memory area, such as a ROM, and makes an inquiry to the control unit 11 as to whether the execution transition information can be used at this point in time. The control unit 11 notifies a result of determination to the client 20.

Once the execution transition information to be used is confirmed, the client 20 sends the execution transition information to the control unit 11 and makes a request to the control unit 11 to perform construction of the processing paths. The control unit 11 allocates the computational resources according to the execution transition information necessary for the execution of the tasks and allocates the processing paths. The client 20 begins the service processing using the constructed processing paths. However, it is not necessary for the client 20 to perform processing related to the service. When the processing related to the service by all the processing elements is completed, the client 20 notifies the control unit 11 of the completion of the processing related to the service. Upon receiving the notification of the completion of the processing related to the service, the control unit 11 deallocates the computational resources and the processing paths. Upon completion of execution of the service requested by the client 20, the control unit 11 notifies the client 20 of the completion of execution of the service.

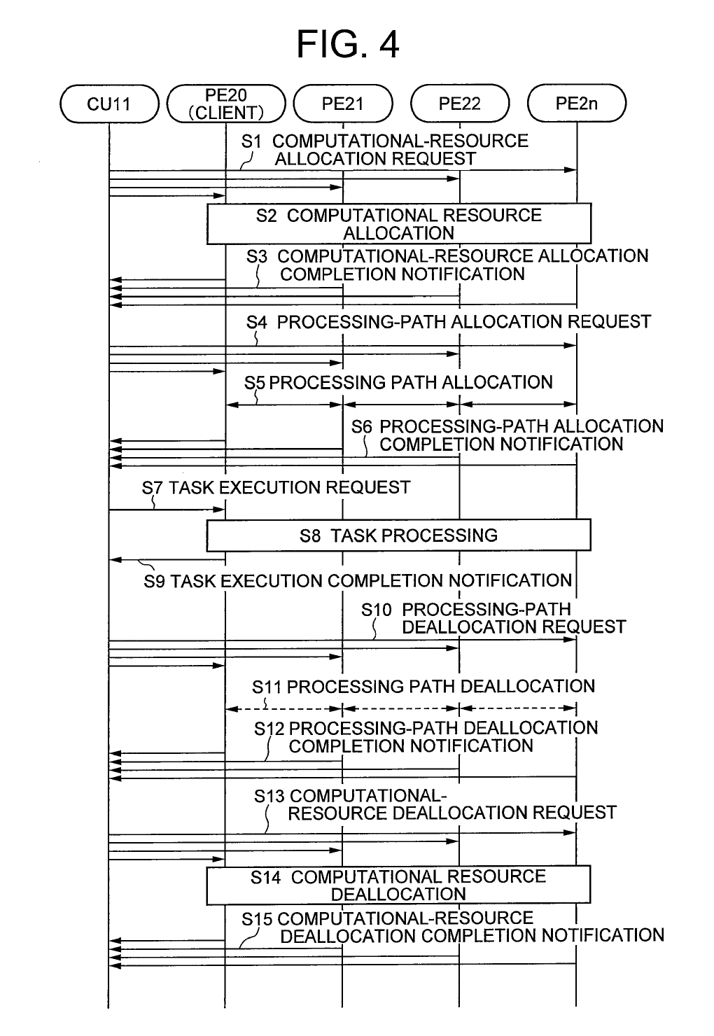

The process procedure of the control unit 11 for generating the execution transition information and providing the same to the client 20 is explained next with reference to FIG. 4. FIG. 4 is a sequence diagram of a process procedure from allocation of the computational resources up to deallocation of the computational resources by the control unit 11 based on the execution transition information. From among the processing elements 20, 21, 22, . . . , 2n, only the processing elements 20, 21, 22, and 2n have been shown in FIG. 4; however, the processes explained below apply equally to the processing elements 23, 24, . . . , 2n-1.

Prior to beginning the process shown in FIG. 4, the client 20 sends a valid execution transition information to the control unit 11 and makes a request for execution of the service to the control unit 11.

The control unit 11 that has received the execution request sends a computational-resource allocation request along with the execution transition information to each of the processing elements 20, 21, 22, . . . , 2n that serve as the computational resources necessary for the processing of the service (Step S1). The processing element 20 serving as the client need not possess the capability to execute the tasks constituting the service and can merely request a service.

However, it is assumed here that the client 20 also possesses the capability of executing the tasks. In an alternative configuration, the execution transition information itself can serve as the computational-resource allocation request.

Upon receiving the computational-resource allocation request and the execution transition information, each of the processing elements allocates the computational resources necessary for task processing according to the execution transition information (Step S2). The term “computational resource” refers to CPU power and memory capacity necessary for the processing.

Upon successful allocation of the computational resources, each of the processing elements returns a computational-resource allocation completion notification to the control unit 11 as a response to the computational-resource allocation request (Step S3). On the other hand, if computational resources cannot be allocated, the processing elements return an error notification to the control unit 11.

When all the computational resources are allocated, the control unit 11 sends a processing-path allocation request to each of the processing elements (Step S4). When all the computational resources could not be allocated, the control unit 11 returns an error notification to the user, deallocates the allocated computational resources, and aborts the service processing.

Each of the processing elements allocates the processing paths according to the execution transition information received at Step S1 (Step S5). The term “processing path allocation” refers to connection of switches and allocation of a connection to TCP/IP network and the like.

Upon successful completion of the processing path allocation, each of the processing elements returns a processing-path allocation completion notification to the control unit 11 as a response to the processing-path allocation request (Step S6). If the processing path allocation fails, the processing elements return an error notification to the control unit 11.

Upon successful completion of allocation of all the processing paths, the control unit 11 sends a task-execution request to the client 20 (Step S7).

If allocation of all the processing paths cannot be completed, the control unit 11 returns an error notification to the user, deallocates the allocated computational resources and the processing paths, and aborts the service processing.

The client 20 starts the processing using the allocated processing paths (Step S8). Each of the processing elements performs task processing on the data input through the allocated processing paths, and outputs the result sequentially.

Upon completion of all the task processing, the client 20 sends a task execution completion notification to the control unit 11 (Step S9).

Upon receiving the task execution completion notification, the control unit 11 sends a processing-path deallocation request to those processing elements to which the computational resources have been allocated (Step S10).

Upon receiving the processing-path deallocation request, each of the processing elements deallocates the allocated processing path (Step S11).

Upon successful completion of deallocation of the processing path, each of the processing elements sends a processing-path deallocation completion notification to the control unit 11 as a response to the processing-path deallocation request (Step S12). On the other hand, if the processing path deallocation fails, the processing elements return an error notification to the control unit 11.

Upon completion of successful deallocation of the processing paths by all the processing elements, the control unit 11 sends a computational-resource deallocation request to those processing elements to which the computational resources have been allocated (Step S13). However, in case of partial or complete failure of the processing path deallocation, the preferred course of action for the control unit 11 is to send the computational-resource deallocation request to the processing elements that succeeded in allocating the computational resources, and enforce the subsequent deallocation process.

Upon receiving the computational-resource deallocation request, each of the processing elements deallocates the allocated computational resources (Step S14).

Each of the processing elements sends a computational-resource deallocation completion notification to the control unit 11 as a response to the computational-resource deallocation request (Step S15). When the computational-resource deallocation fails, the processing elements return an error notification to the control unit 11. Upon receiving the computational-resource deallocation completion notification from all the processing elements, the control unit 11 completes the service processing. It is preferable that the service processing be forcefully terminated when an error occurs.

When the execution of the services requested by the client 20 is completed by the process procedure described above, the control unit 11 notifies the client 20 of the completion of the execution of the service.

The process procedure explained with reference to FIG. 4 relates to a situation where no service processing is performed before or after the service in question, or relates to a situation where the service performed before or after the service in question does not use the same computational resources or the processing paths as the service in question. When the service performed sequentially before or after the service in question uses the same computational resources and the processing paths as the service in question, some or all of the processing among allocation and deallocation of the computational resources and allocation and deallocation of the processing paths may become unnecessary.

Further, in the process procedure explained with reference to FIG. 4, it is assumed that the control unit 11 broadcasts allocation and deallocation requests pertaining to the computational resources and the processing paths to all the processing elements. However, the control unit 11 can be configured to communicate with each of the processing elements individually.

Further, when sending the execution transition information, only the portion relevant to each of the processing elements can be sent to the respective processing element. In an alternative configuration, the entire information can be sent to all the processing elements.

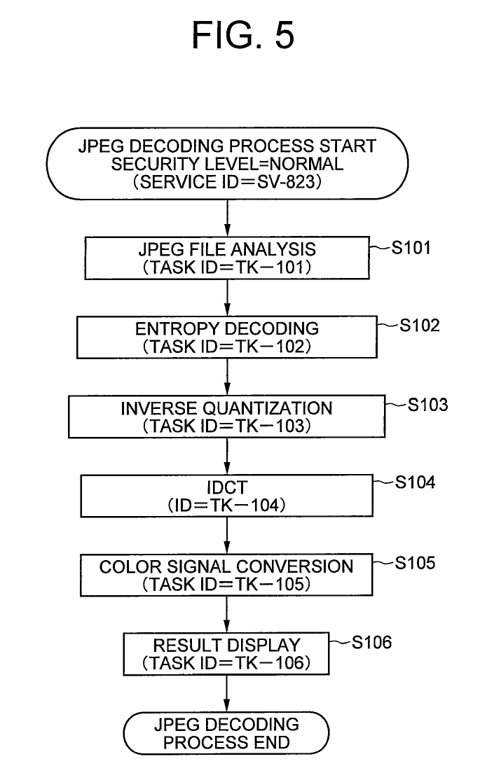

FIG. 5 is a flowchart of an application process corresponding to the service-task correspondence table shown in FIG. 2. In the example shown in FIG. 5, the JPEG decoding process (service ID=SV-823) is executed sequentially in the order of JPEG file analysis (task ID=TK-101, Step S101), entropy decoding (task ID=TK-102, Step S102), inverse quantization (task ID=TK-103, Step S103), IDCT (task ID=TK-104, Step S104), color signal conversion (task ID=TK-105, Step S105), and result display (task ID=TK-106, Step S106), and the JPEG decoding process ends.

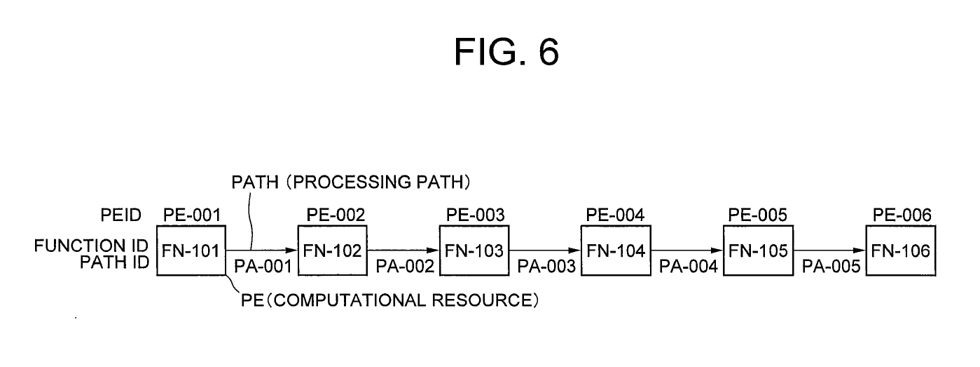

A system that includes the execution transition information explained with reference to FIG. 5 is explained with reference to FIG. 6. FIG. 6 is a schematic diagram of an exemplary model of a system that is compatible with the configuration of the execution transition information. In this system, six processing elements (PEID: PE-001 to PE-006 and function ID: FN-101 to FN-106) are sequentially connected to form five paths assigned with the path IDs PA-001 to PA-005. For example, the processing element that serves as the source (PEID: PE-001) and the processing element that serves as the destination (PEID: PE-002) are connected by the path having the path ID PA-001.

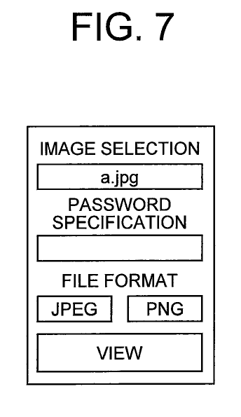

An example of a client application is explained next with reference to FIG. 7. FIG. 7 is a schematic diagram of an exemplary screen of a client application that is used for decoding and displaying images.

The client 20 selects an image to be decoded. The selectable file formats of the image are JPEG and PNG. The image can be viewed after making the necessary configurations and clicking the “view” button. The service ID and the pattern ID are determined according to the parameters the user has configure in the client application.

The level of security for the exemplary client application explained with reference to FIGS. 5 and 7 is not configured high enough to require a password.

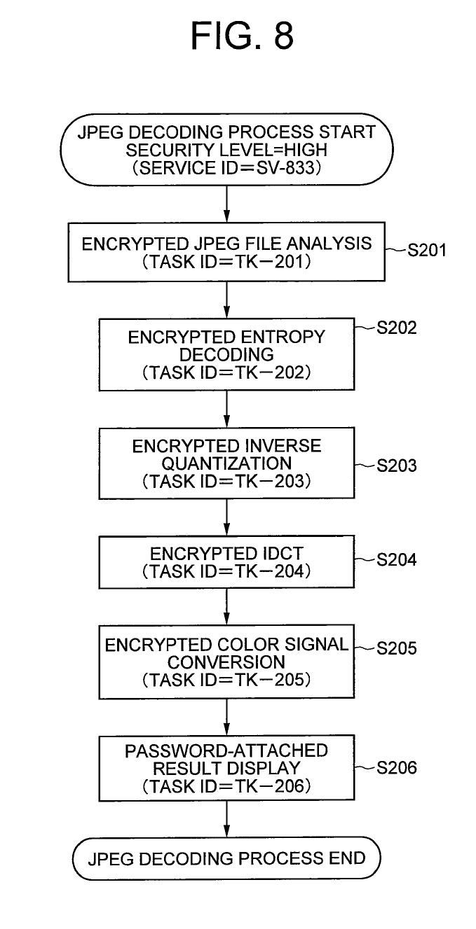

With reference to FIGS. 8 to 10, an exemplary client application is explained in which a higher level of security has been configured as compared to the case explained with reference to FIGS. 5 and 7. In the example explained with reference to FIGS. 8 to 10, all the input/output data in every module are encrypted.

In all the examples shown in FIGS. 5 to 10, information about the security level is stored in a memory area of a ROM or the like that is not accessible to the user. In other words, a configuration has been adopted in which the user cannot be freely configured or alter the security level.

FIG. 8 is a flowchart of an application process corresponding to the service-task correspondence table shown in FIG. 2 and corresponds to a case where a high security level has been configured. In the example shown in FIG. 8, a high security level JPEG decoding process (service ID=SV-833) is executed sequentially in the order of encrypted JPEG file analysis (task ID=TK-201, Step S201), encrypted entropy decoding (task ID=TK-202, Step S202), encrypted inverse quantization (task ID=TK-203, Step S203), encrypted IDCT (task ID=TK-204, Step S204), encrypted color signal conversion (task ID=TK-205, Step S205), and password-attached result display (task ID=TK-206, Step S206), and the JPEG decoding process is terminated.

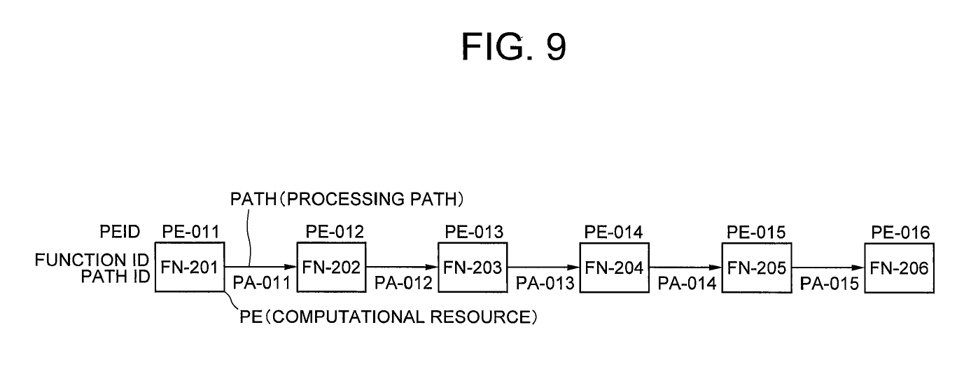

FIG. 9 is a schematic diagram of an exemplary model of a system that is compatible with the configuration of the execution transition information. More specifically, six processing elements (PEID: PE-011 to PE-016, and function ID: FN-201 to FN-206) are sequentially connected to form five paths assigned with the path IDs PA-011 to PA-015. For example, the processing element that serves as the source (PEID PE-011) and the processing element that serves as the destination (PEID PE-012) are connected by the path having the path ID PA-011.

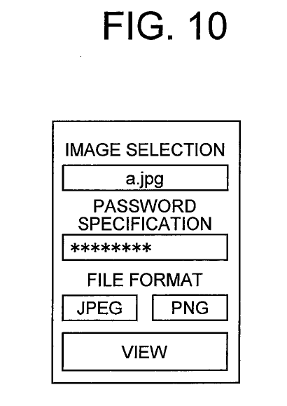

FIG. 10 is a schematic diagram of an exemplary screen of a client application that is used for decoding and displaying images and corresponds to a case where a high security level has been configured. In contrast to the example shown in FIG. 7, password specification is required in the example shown in FIG. 10. In other words, the client 20 selects an image for decoding and also specifies a password. The selectable file formats of the image are JPEG and PNG. The image can be viewed after making the necessary configurations and clicking the “view” button. The service ID and the pattern ID are determined according to the parameters the user has been configured in the client application.

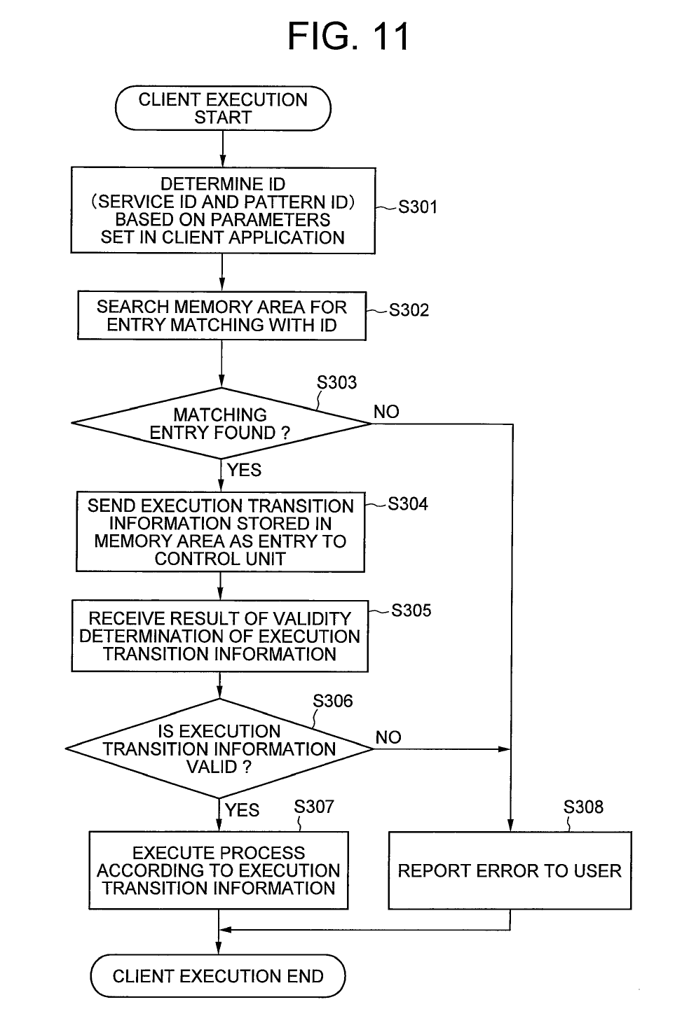

FIG. 11 is a flowchart for explaining a process procedure performed by the client 20.

To begin with, the client 20 determines the service ID and the pattern ID according to the parameters configuration in the client application (Step S301).

The client 20 then searches the memory area of the ROM or the like for an entry matching the service ID and the pattern ID (Step S302).

If a matching entry is found (Yes at Step 5303), the client 20 sends the execution transition information stored as the entry in the memory area to the control unit 11 (Step S304).

The control unit 11 performs a validity determination of the execution transition information received from the client 20.

More specifically, upon receiving the execution transition information from the client 20, the control unit 11 analyzes whether the computational resources (processing elements) and the processing paths (paths) constituting the execution transition information can be used. As a result, when the control unit 11 determines that some or all of the computational resources and the processing paths are already being used by other service, or when allocation of the computational resources and processing paths is not possible due to deregistration of a processing element, the control unit 11 determines the entry in the memory area to be invalid.

The control unit 11 sends a result of the validity determination to the client 20 and the client 20 receives the result of the validity determination (Step S305).

When the execution transition information is determined by the control unit 11 to be valid (Yes at Step S306), each of the processing elements executes the tasks constituting the service according to the execution transition information (Step S307). Upon completion of execution of all the tasks, the execution of the service and the execution of the process procedure by the client 20 are terminated.

If no matching entries are found in the memory area of the ROM or the like (No at Step S303), the client 20 reports an error to the user (Step S308) and terminates the process procedure.

Even in a situation where the execution transition information is determined by the control unit 11 to be invalid (No at Step S306), the client 20 reports an error to the user (Step S308) and terminates the process procedure.

Thus, by the process procedure described above, each of the processing elements executes the task constituting the service according to the execution transition information thereby executing the service.

The path information is identified by a unique ID information. Though any search condition can be used to search the memory area, the preferred search conditions are the service ID and the pattern ID.

The control unit 11 manages the information about all the tasks that are being executed, so that the control unit 11 can determine whether the processing elements can be allocated the services constituting the task and can be used as the computational resources. The control unit 11 similarly determines whether the processing paths can be used. If the computational resources and the processing paths can be used, the control unit 11 determines them to be valid. If not, the control unit 11 determines them to be invalid.

In this manner, by constraining the execution transition information that can be used by the user to that which meets the security and privacy conditions for execution, storing the execution transition information in a memory area of the client, and determining whether the requested service can be provided according to the execution transition information, the distributed processing system, the control unit, and the client according to the present invention are adapted to ensure that the user is provided with the requested service while meeting the execution conditions.

A distributed processing system, a control unit, and a client according to the present invention are adapted to ensure that a service requested by a user is provided while meeting security and privacy conditions for execution by constraining the execution transition information that can be used by the user to that which meets the security and privacy conditions for execution, storing the execution transition information in the memory area of the client, and determining whether the requested service can be provided according to the execution transition information.

What is claimed is:

1. A distributed processing system comprising:
a client that makes an execution request for a service requested by a user;
a processing element; and
a control unit to which the client and the processing element are connected, wherein
the client stores therein execution transition information about computational resources and processing paths for controlling the processing element, and
the processing element executes the service by executing tasks constituting the service according to the execution transition information.

2. The distributed processing system according to claim 1, wherein the execution transition information is stored beforehand in a memory area in the client.

3. The distributed processing system according to claim 1, wherein the control unit includes a determining unit that receives, when the execution request for the service is made by the client, the execution transition information corresponding to the service from among the execution transition information stored in the client and performs a validity determination of the execution transition information, and notifies the client of a result of the validity determination made by the determining unit.

4. The distributed processing system according to claim 3, wherein the control unit controls the processing element by using the execution transition information.

5. The distributed processing system according to claim 2, wherein the client performs a determination as to whether to send the execution transition information to the control unit based on the service requested by the user, and sends the execution transition information to the control unit according to a result of the determination.

6. The distributed processing system according to claim 1, wherein the client retrieves, upon receiving the execution request for the service from the user, whether the execution transition information corresponding to the service requested by the user is available in the stored execution transition information.

7. The distributed processing system according to claim 6, wherein, when a result of the retrieval shows that the execution transition information corresponding to the service is available, the client sends the available execution transition information to the control unit.

8. The distributed processing system according to claim 6, wherein, when a result of the retrieval shows that the execution transition information corresponding to the service is not available, the client notifies the user the result of the retrieval.

9. The distributed processing system according to claim 3, wherein, when the result of the validity determination performed by the determining unit shows that the execution transition information corresponding to the service is invalid, the control unit notifies the result of the validity determination to the user.

10. A control unit to which are connected a client that makes an execution request for a service, and a processing element, wherein the control unit
includes a determining unit that receives, when the execution request for the service is made by the client, execution transition information corresponding to the service from among execution transition information stored in the client and performs a validity determination of the execution transition information, and
notifies the client of a result of the validity determination made by the determining unit.

11. The control unit according to claim 10, wherein the execution transition information is used for controlling the processing elements.

12. A client that is connected to a control unit of a distributed processing system and that makes an execution request for a service requested by a user, wherein
the client stores therein execution transition information about computational resources and processing paths used for controlling a processing element.

13. The client according to claim 12, wherein the execution transition information is stored beforehand in a memory area.

14. The client according to claim 12, wherein the client performs a determination as to whether to send the execution transition information to the control unit based on the service requested by the user, and sends the execution transition information to the control unit according to a result of the determination.

15. The client according to claim 12, wherein the client retrieves, upon receiving the execution request for the service from the user, whether the execution transition information corresponding to the service requested by the user is available in the stored execution transition information.

16. The client according to claim 15, wherein, when a result of the retrieval shows that the execution transition information corresponding to the service is available, the client sends the available execution transition information to the control unit.

17. The client according to claim 15, wherein, when a result of the retrieval shows that the execution transition information corresponding to the service is not available, the client notifies the user the result of the retrieval.
